(19) United States
(12) Patent Application Publication
(10) Pub. No.: US 2020/0278040 A1
(43) Pub. Date: Sep. 3, 2020

(54) Check Valve, Container and Oral Irrigator

(71) Applicant: Freeman Intelligent Power Inc, Rowland Heights, CA (US)

(72) Inventor: Xiaoyue Huang, Rowland Heights, CA (US)

(21) Appl. No.: 16/874,669

(22) Filed: May 14, 2020

(51) Int. Cl. F16K 15/14; A61C 1/00; A61C 17/02

(52) U.S. Cl. CPC F16K 15/147; A61C 17/02; A61C 1/0084

(57) ABSTRACT

The invention discloses a check valve, a container and an oral irrigator. The check valve is made of an elastic material and comprises a valve body part with a hollow structure, wherein an opening communicated with the hollow structure is formed in the top of the valve body part, the valve body part comprises two opposite connection walls and two opposite membranes, two opposite sides of each connection wall are respectively connected to the two membranes, the tops of the two membranes are away from each other, and the bottoms of the two membranes abut against each other. The check valve has a leakage prevention function and a ventilation function. The check valve is simple in structure, easy to machine, low in production cost, small in size, good in structural stability and long in service life and occupies a small space.

### TECHNICAL FIELD

The invention relates to the technical field of check valves, in particular to a check valve, a container and an oral irrigator.

### DESCRIPTION OF RELATED ART

Check valve structures are arranged on some containers (such as the water tank of oral irrigators) to balance internal and external pressures of the containers so as to prevent substances (such as liquid) from flowing out of the containers. In the prior art, impermeable and breathable films are typically used to fulfill ventilation and avoid leakage of enclosed containers. Although the impermeable and breathable films can avoid liquid leakage, these films have a poor ventilation effect and may be broken under the atmospheric pressure when liquid in the containers is pumped out at a high rate.

### BRIEF SUMMARY OF THE INVENTION

The technical issue to be settled by the invention is to provide a breathable leakage-proof check valve, a container provided with the check valve, and an oral irrigator provided with the container.

A first technical solution adopted by the invention to settle the aforesaid technical issue is to provide a check valve, which is made of an elastic material and comprises a valve body part with a hollow structure, wherein an opening communicated with the hollow structure is formed in the top of the valve body part, the valve body part comprises two opposite connection walls and two opposite membranes, two opposite sides of each connection wall are respectively connected to the membranes, the tops of the two membranes are away from each other, and the bottoms of the two membranes abut against each other.

A second technical solution adopted by the invention to settle the aforesaid technical issue is to provide a container, which comprises the check valve.

A third technical solution adopted by the invention to settle the aforesaid technical issue is to provide an oral irrigator, which comprises the container.

The invention has the following beneficial effects: after the check valve is assembled on the container, the two membranes with the bottoms abutting against each other block a connection channel between the hollow structure of the check valve and an inner cavity of the container to prevent substances in the container from leaking via the check valve, so that a leakage prevention function of the check valve is realized; and when the air pressure in the container is lower than the external atmospheric pressure, external air will burst the two members to enable the bottoms of the two membranes to move away from each other to unblock the connection channel between the hollow structure of the check valve and the inner cavity of the container, so that a ventilation function of the check valve is realized. The check valve is simple in structure, easy to machine, low in production cost, small in size, good in structural stability and long in service life and occupies a small space.

### DETAILED DESCRIPTION OF THE SEVERAL VIEWS OF THE DRAWINGS

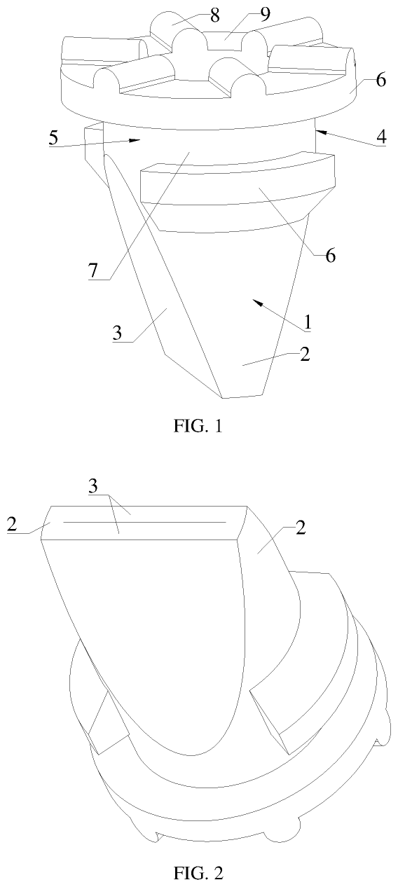

FIG. 1 is a structural diagram of a check valve in Embodiment 1 of the invention;

FIG. 2 is a structural diagram from another perspective of the check valve in Embodiment 1 of the invention;

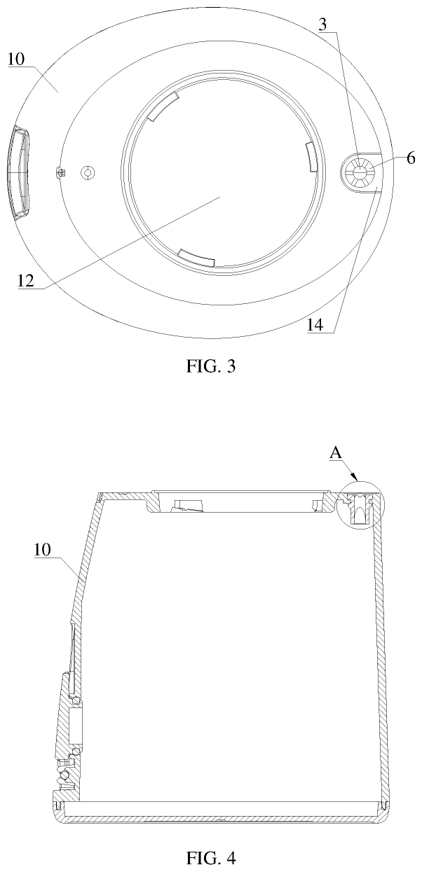

FIG. 3 is a top view of a container in Embodiment 2 of the invention;

FIG. 4 is a sectional view of Embodiment 2 of the invention;

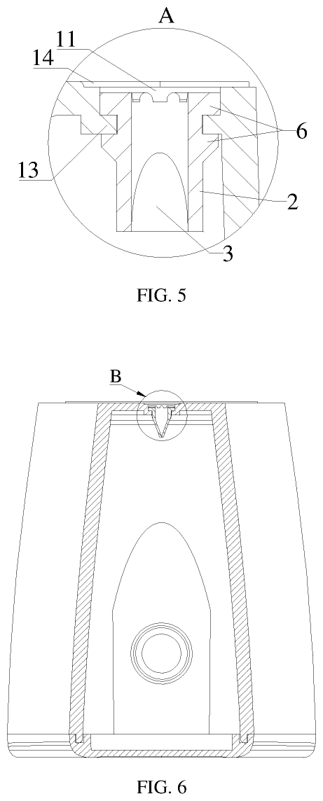

FIG. 5 is an enlarged view of part A in FIG. 4:

FIG. 6 is a sectional view from another perspective of the container in Embodiment 2 of the invention;

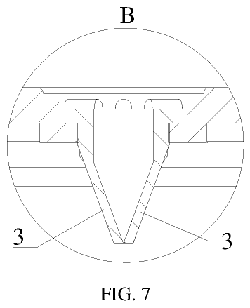

FIG. 7 is an enlarged view of part B in FIG. 6.

### REFERENCE SIGNS

1, valve body part; 2, connection wall; 3, membrane; 4, fixing part; 5, column part; 6, limit ring; 7, limit groove; 8, convex rib; 9, groove; 10, body; 11, air port; 12, liquid inlet/outlet; 13, snap ring; 14, ventilation groove.

### DETAILED DESCRIPTION OF THE INVENTION

The technical contents, purposes and effects of the invention are expounded below in conjunction with the embodiments and accompanying drawings.

Referring to FIG. 1 to FIG. 7, a check valve is made of an elastic material and comprises a valve body part 1 with a hollow structure, wherein an opening communicated with the hollow structure is formed in the top of the valve body part 1, the valve body part 1 comprises two opposite connection walls 2 and two opposite membranes 3, two opposite sides of each connection wall 2 are respectively connected to the two membranes 3, the tops of the two membranes 3 are away from each other, and the bottoms of the two membranes 3 abut against each other.

The structure/working principle of the invention is as follows: after the check valve is assembled on a container, the two membranes 3 with the bottoms abutting against each other block a connection channel between the hollow structure of the check valve and an inner cavity of the container to prevent substances in the container from leaking via the check valve, so that a leakage prevention function of the check valve is realized; and when the air pressure in the container is lower than the external atmospheric pressure, external air will burst the two members 3 to enable the bottoms of the two membranes 3 to move away from each other to unblock the connection channel between the hollow structure of the check valve and the inner cavity of the container, so that a ventilation function of the check valve is realized.

From the above description, the invention has the beneficial effect that the check valve is simple in structure, easy to machine, low in production cost, small in size, good in structural stability and long in service life and occupies a small space.

Furthermore, the thickness of the membranes 3 is smaller than that of the connection walls 2.

From the above description, the structural strength of the connection walls 2 is higher than that of the membranes 3, so that the membranes 3 can deform more easily, and the opening/closing sensitivity of the check valve is improved.

Furthermore, at least one membrane 3 becomes thicker gradually from bottom to top.

From the above description, the membranes become thicker gradually from bottom to top, so that both the structural strength and deformability of the membranes 3 are guaranteed. Understandably, when the thickness of one membrane 3 is kept consistent with that of the connection walls 2, the check valve provided by the invention is actually a single-membrane 3 check valve.

Furthermore, the two membranes 3 are arranged in a V shape.

Furthermore, the check valve further comprises a fixing part 4 which is connected to the top of the valve body part 1.

From the above description, the check valve is fixed to a container by means of the fixing part 4.

Furthermore, the fixing part 4 comprises a column part 5 formed with a through hole, and the through hole is communicated with the hollow structure via the opening.

From the above description, through the design of the shape of the column part 5 and the design of the relative positions of the column part 5 and the valve body part 1, the entire check valve can be in different shapes to adapt different application scenarios. For example, the check valve is I-shaped, L-shaped, J-shaped, or the like.

Furthermore, a limit part is arranged on the outer wall of the column part 5.

From the above description, the check valve is fixed to a container by means of the limit part.

Furthermore, the limit part comprises two limit rings 6 which are spaced from each other, wherein a limit groove 7 is formed between the two limit rings 6, the limit ring 6 away from the valve body part 1 is located at an end of the fixing part 4 and has a top surface provided with a plurality of convex ribs 8 which are spaced from one another, and a groove 9 through which the outer wall of the limit ring 6 is communicated with the through hole is formed between every two adjacent convex ribs 8.

From the above description, through the design of the grooves 9, the ventilation capacity of the check valve can be improved, and the check valve can be prevented from being blocked.

A container comprises the check valve.

An oral irrigator comprises the container.

### Embodiment 1

Referring to FIG. 1 and FIG. 2, Embodiment 1 of the invention provides a check valve which is made of an elastic material and comprises a valve body part 1 with a hollow structure, wherein an opening communicated with the hollow structure is formed in the top of the valve body part 1, the valve body part 1 comprises two opposite connection walls 2 and two opposite membranes 3, two opposite sides of each connection wall 2 are respectively connected to the two membranes 3, the tops of the two membranes 3 are away from each other to form the opening, and the bottoms of the two membranes 3 abut against each other to seal the bottom end of the hollow structure. Understandably, the opening is formed in the top end of the valve body part 1 or in a side wall of the valve body part 1.

Optionally, to guarantee the leakage prevention effect of the check valve, abutting planes are formed on the sides, close to each other, of the two membranes 3, and the two membranes 3 abut against each other by means of the abutting planes. In other words, the two membranes 3 are in surface contact.

The elastic material includes, but is not limited to, silica gel, rubber, soft plastic, and the like. In this embodiment, the check valve is made of silica gel with a hardness of 20 duro-100 duro.

The thickness of the membranes 3 is smaller than that of the connection walls 2 to ensure that the deformation degree of the membranes 3 is greater than that of the connection walls 2. At least one membrane 3 becomes thicker gradually from bottom to top, so that the bottom of the membrane 3 is more likely to deform, and the structural stability of the check valve is guaranteed.

The two membranes 3 are arranged in a V shape. Understandably, in the case where the two membranes 3 are not presented in a V shape from some perspectives and are presented in a V shape from a certain perspective when the check valve is rotated/turned, the two membranes 3 should also be appreciated as being arranged in a V shape.

When laterally viewed, the connection walls 2 are in an inverted triangle shape or in an inverted trapezoid shape.

The check valve further comprises a fixing part 4 which is connected to the top of the valve body part 1. Understandably, the fixing part 4 and the valve body part 2 are of an integrated structure, that is, the fixing part 4 and the valve body part 1 are integrally formed by injection molding. Specifically, the fixing part 4 comprises a column part 5 formed with a through hole, and the through hole is communicated with the hollow structure via the opening. More specifically, a limit part is arranged on the outer wall of the column part 5. In this embodiment, the limit part comprises two limit rings 6 which are spaced from each other, wherein a limit groove 7 is formed between the two limit rings 6, the limit ring 6 away from the valve body part 1 is located at an end of the fixing part 4 and has a top surface provided with a plurality of convex ribs 8 which are spaced from one another, and a groove 9 through which the outer wall of the limit ring 6 is communicated with the through hole is formed between every two adjacent convex ribs 8. Optionally, the convex ribs 8 are arranged in a radial direction of the column part 5.

In this embodiment, the column part 5 is cylindrical. In other embodiments, the column part 5 is J-shaped, L-shaped, or the like, and the column part 5 with a bent area can protect abutting areas of the two membranes 3 against a direct impact from substances in a container, so that the leakage prevention effect is further improved.

### Embodiment 2

Referring to FIG. 1 to FIG. 7, Embodiment 2 of the invention provides a container structure on the basis of Embodiment 1. Particularly, a container comprises a body 10 and a check valve arranged on the body 10, wherein the check valve is the check body described in Embodiment 1.

The body 10 has an air port 11 and at least one liquid inlet/outlet 12, wherein a snap ring 13 is arranged in the air port 11, the check valve is clamped on the container through the cooperation of the snap ring 13 and the limit groove 7, the air port 11 is formed in the top of the container, and a ventilation groove 14 communicated with the air port 11 is formed in the top surface of the container and extends to the outer wall of the container. Preferably, the top surface of the check valve is lower than the bottom surface of the ventilation groove 14.

In this embodiment, the container is a water tank of an oral irrigator. In other embodiments, the container may be a food box, a fermentation tank, an infusion bottle, or the like. The check valve can balance internal and external pressures of the container, so that the problems that liquid in the container cannot be easily pumped out and a container cover is difficult to open are effectively solved.

According to the check valve, the container and the oral irrigator provided by the invention, the check valve is simple in structure, easy to machine, low in production cost, small in size, good in structural stability and long in service life and occupies a small space; and internal and external pressures of the container are balanced, so that liquid can be smoothly pumped out of the container.

The aforesaid embodiments are only possible ones of the invention, and are not intended to the limit the patent scope of the invention. All equivalent transformations made on the basis of the contents of the specification and accompanying drawings of the invention, or direct or indirect applications to relating technical fields should also fall within the patent protection scope of the invention.

What is claimed is:

1. A check valve, being made of an elastic material and comprising a valve body part with a hollow structure, wherein an opening communicated with the hollow structure is formed in a top of the valve body part, the valve body part comprises two opposite connection walls and two opposite membranes, two opposite sides of each said connection wall are respectively connected to the two membranes, tops of the two membranes are away from each other, and bottoms of the two membranes abut against each other.

2. The check valve according to claim 1, wherein a thickness of the membranes is smaller than that of the connection walls.

3. The check valve according to claim 1, wherein at least one of the membranes becomes thicker gradually from bottom to top.

4. The check valve according to claim 1, wherein the two membranes are arranged in a V shape.

5. The check valve according to claim 1, further comprising a fixing part which is connected to the top of the valve body part.

6. The check valve according to claim 5, wherein the fixing part comprises a column part formed with a through hole, and the through hole is communicated with the hollow structure via the opening.

7. The check valve according to claim 6, wherein a limit part is arranged on an outer wall of the column part.

8. The check valve according to claim 7, wherein the limit part comprises two limit rings which are spaced from each other, a limit groove is formed between the two limit rings, the limit ring away from the valve body part is located at an end of the fixing part and has a top surface provided with a plurality of convex ribs which are spaced from one another, and a groove through which an outer wall of the limit ring is communicated with the through hole is formed between every two adjacent said convex ribs.

9. A container, comprising the check valve according to claim 1.

10. A container, comprising the check valve according to claim 2.

11. A container, comprising the check valve according to claim 3.

12. A container, comprising the check valve according to claim 4.

13. A container, comprising the check valve according to claim 5.

14. A container, comprising the check valve according to claim 6.

15. A container, comprising the check valve according to claim 7.

16. A container, comprising the check valve according to claim 8.

17. An oral irrigator, comprising the container according to claim 9.

18. An oral irrigator, comprising the container according to claim 11.

19. An oral irrigator, comprising the container according to claim 12.

20. An oral irrigator, comprising the container according to claim 16.
